(19) United States
(12) Patent Application Publication
(10) Pub. No.: US 2021/0151748 A1
(43) Pub. Date: May 20, 2021

(54) SOLID-STATE LITHIUM METAL BATTERY BASED ON THREE-DIMENSIONAL ELECTRODE DESIGN

(71) Applicant: The Board of Trustees of the Leland Stanford Junior University, Stanford, CA (US)

(72) Inventors: Yayuan LIU, Stanford, CA (US); Yi CUI, Stanford, CA (US); Dingchang LIN, Stanford, CA (US)

(73) Assignee: The Board of Trustees of the Leland Stanford Junior University, Stanford, CA (US)

(21) Appl. No.: 16/616,910

(22) PCT Filed: May 14, 2018
(86) PCT No.: PCT/US2018/032522

§ 371 Date: Nov. 25, 2019

Related U.S. Application Data
(60) Provisional application No. 62/513,374, filed on May 31, 2017.

(51) Int. Cl. H01M 4/38; H01M 10/0525; H01M 4/134; H01M 4/1395; H01M 4/36; H01M 4/583

(52) U.S. Cl. CPC H01M 4/382; H01M 10/0525; H01M 4/583; H01M 4/1395; H01M 4/366; H01M 4/134

(57) ABSTRACT

A composite lithium metal anode includes: (1) a porous matrix; and (2) a flowable interphase and lithium metal disposed within the porous matrix.

### CROSS-REFERENCE TO RELATED APPLICATION

This application claims the benefit of U.S. Provisional Application No. 62/513,374, filed May 31, 2017, the contents of which are incorporated herein by reference in their entirety.

### STATEMENT REGARDING FEDERALLY SPONSORED RESEARCH OR DEVELOPMENT

This invention was made with Government support under contract DE-ACO2-76SF00515 awarded by the Department of Energy. The Government has certain rights in the invention.

### BACKGROUND

Lithium (Li)-based rechargeable batteries are playing a vital role in modern society. These batteries are the dominant power source for consumer electronics, and also the most prominent energy storage technology for the widespread adoption of electric vehicles (EVs). Nevertheless, it has been recognized that batteries with higher energy and power densities are desired to accelerate the electrification of transportation, involving battery chemistries beyond the state-of-art Li-ion. To realize such goal, Li metal is the anode of choice, due to its highest theoretical capacity (3860 mAh g¹) and lowest electrochemical potential (−3.04 V versus standard hydrogen electrode). However, the practical applications of Li metal anode have been severely hindered by the problems of poor cycle life and serious safety concerns, originating from its high reactivity with organic liquid electrolyte and the uneven deposition behavior (dendrites), the latter of which can potentially incur thermal runaway and explosion hazards by internally short-circuiting cells.

To address the aforementioned challenges and render Li metal anode a viable technology, an attractive strategy is to replace volatile liquid electrolytes with non-flammable solid counterparts that are electrochemically stable against Li and mechanically robust to suppress dendrites. Although a wide variety of solid electrolytes for Li batteries have been developed throughout the years, ranging from inorganic ceramic electrolytes to solid polymer electrolytes (SPEs), a common challenge awaits to be solved for these systems, which is the interfacial detachment between solid electrolytes and electrodes.

Unlike liquid electrolytes, solid electrolytes typically barely possess any fluidity to form a continuous contact with electrode active materials. Therefore, an electrochemical process can be severely constrained by the contact area, leading to large interfacial resistance and low utilization of electrode capacity. The issue is even more pronounced for Li metal anode, whose interfacial fluctuation (specified as the degree of Li surface movement during cycling) in practical applications can be as large as tens of microns (e.g., about 1 mAh cm⁻² corresponds to about 5 μm Li in thickness), making it difficult to cycle solid-state Li batteries at high capacity and current density. And the uneven current distribution due to poor interfacial contact may also promote dendrite growth. Improvements are desired such that good interfacial contact can be realized without compromising non-flammability, mechanical properties (the “modulus versus adhesion dilemma”), or the engineering cost of the solid electrolytes. Noticeably, other strategies are developed based on a planar Li foil, which can barely remain effective under high areal capacity cycling due to drastic interfacial fluctuation, and a current density that planar Li can endure is not high enough, impeding a high-power operation of cells.

It is against this background that a need arose to develop embodiments of this disclosure.

### SUMMARY

In some embodiments, a composite lithium metal anode includes: (1) a porous matrix; and (2) a flowable interphase and lithium metal disposed within the porous matrix.

In some embodiments, a lithium battery includes: (1) a cathode; (2) a composite lithium metal anode; and (3) an electrolyte disposed between the cathode and the composite lithium metal anode. The composite lithium metal anode includes: (a) a porous matrix; and (b) a flowable interphase and lithium metal disposed within the porous matrix.

In some embodiments, a method of manufacturing a composite lithium metal anode includes: (1) providing a porous matrix; (2) infusing liquefied lithium metal into the porous matrix; and (3) infusing a composition including a polymer and a plasticizer into the porous matrix.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Schematics illustrating a fabrication process of a three-dimensional (3D) Li anode with flowable interphase for solid-state Li battery. (a) 3D Li in layered reduced graphene oxide host (3D Li-rGO) composite anode is first fabricated. (b) A flowable interphase for the 3D Li-rGO anode is created via thermal infiltration of liquid-like poly(ethylene glycol) plasticized by bis(trifluoromethane)sulfonimide Li salt (PEG-LiTFSI) at a temperature of about 150° C. (c) A composite polymer electrolyte (CPE) layer composed of poly(ethylene oxide) (PEO), LiTFSI and fumed silica or a cubic garnet-type Li_{6.5}La₃Zr_{0.5}Ta_{1.5}O₁₂ (LLZTO) ceramic membrane is employed as the middle layer, and a high-mass loading LiFePO₄ (LFP) cathode with the CPE as a binder is overlaid to construct the solid-state Li-LFP full cell.

FIG. 2. Characterizations of a flowable PEG and a CPE middle layer. (a) Complex viscosity of the flowable PEG as a function of temperature at about 10 Hz obtained via rheology measurements. Inset is a digital photo image of the flowable PEG at room temperature. Scanning electron microscopy (SEM) and digital photo images of a 3D Li-rGO anode (b, d) before and (c, e) after thermal infiltration of the flowable PEG. (f) Differential scanning calorimetry (DSC) thermograms of pure PEO, CPE middle layer and flowable PEG. The endothermic peak of pure PEO at about 65° C. corresponds to the melting of crystalline PEO. (g) Ionic conductivity and (h) electrochemical stability window of the flowable PEG and the CPE middle layer. Cyclic voltammetry (CV) scans for the determination of the electrochemical stability windows were carried out at a scan rate of about 0.1 mV s⁻¹.

FIG. 3. Galvanostatic cycling of symmetric cells using 3D Li-rGO with flowable interphase and planar Li foil electrodes at about 60° C. (a) Schematic illustrating the micron scale volume change and uneven Li stripping/plating of a Li foil anode, which render it challenging for a solid electrolyte to maintain a continuous contact during cycling. As a “hostless” electrode, the volume of the electrode contracts and expands during Li stripping and plating, respectively. For a practical battery, the areal capacity of a single-sided electrode is about 3 mAh cm⁻², corresponding to a relative change in thickness of about 15 μm for Li. Moreover, Li tends to be cycled in a non-uniform fashion as localized stripping (pitting) and dendritic plating are observed. The non-uniform, micron scale electrode-electrolyte interphase movement prevents the formation of a good contact. (b) Schematic illustrating the advantages of the 3D Li-rGO anode for solid-state Li batteries. The significantly reduced interfacial fluctuation due to increased Li surface area and the flowable nature of the interphase polymer electrolyte are beneficial for maintaining an intimate electrode-electrolyte contact during cycling. (c) Voltage profiles at different current densities. The charging/discharging time was fixed at about 1 hour for all the current densities except at about 1 mA cm⁻² (about 30 min charging/discharging) and with about 30 min rest in between. (d, e) Detailed voltage profiles at a current density of about 0.1 mA cm⁻² and about 0.5 mA cm⁻², respectively. (f) Comparison of the long-term cycling stability of the symmetric cells with Li-rGO electrodes and Li foil electrodes at a current density of about 0.5 mA cm⁻².

FIG. 4. Electrochemical performance of solid-state Li-LFP batteries with CPE as a middle layer. (a) Rate capability and (b, c) the corresponding galvanostatic charge/discharge voltage profiles of Li-LFP full cells using either 3D Li-rGO or Li foil as an anode at an operation temperature of about 60° C. (d) Long-term cycling performance of batteries at a current density of about 1 mA cm⁻² and an operation temperature of about 60° C. (e) Rate capability and (f, g) the corresponding galvanostatic charge/discharge voltage profiles of Li-LFP full cells using either 3D Li-rGO or Li foil as an anode at an operation temperature of about 80° C. (h) Long-term cycling performance of batteries at a current density of about 3 mA cm⁻² and an operation temperature of about 80° C. The areal capacity of the cathode is about 1 mAh cm⁻² and 1 C=170 mA g⁻¹.

FIG. 5. Electrochemical performance of solid-state Li-LFP batteries with LLZTO as a middle layer. (a) Schematic of the solid-state cells with 3D Li-rGO or Li foil anode, LLZTO solid electrolyte middle layer and LFP cathode. About 10 μL of flowable PEG was introduced on top of the Li foil and LFP cathode to improve the interfacial adhesion. (b) Digital photo image of the translucent polished LLZTO membrane. (c) A working solid-state cell using 3D Li-rGO with flowable interphase as the anode powering a light-emitting diode device. (d) Galvanostatic charge/discharge voltage profiles and (e) cycling performance of Li-LFP full cells using either 3D Li-rGO or Li foil as the anode at room temperature.

FIG. 6. (a) Schematic illustration of a fabrication process of a porous Li-rGO composite electrode. Starting with densely stacked GO film, a “spark reaction” in the presence of molten Li expands and partially reduces the GO film into a more porous layered rGO host. When the porous layered rGO film is put into contact again with molten Li, Li can be drawn into the host matrix rapidly to form the porous Li-rGO composite. (b) Schematic illustrating the mechanism of molten Li infusion into the porous layered rGO film. The strong interaction between Li and the remaining oxygen-containing surface functional groups of rGO results in a lithiophilic surface (good wettability by molten Li). The capillary force on a poor wetting surface will lower the liquid level while a good wetting surface will raise the liquid level. The height of the liquid level is inversely proportional to the dimension of the gaps. Therefore, the nanoscale gaps between the rGO layers can provide strong capillary force to drive the molten Li intake into the rGO host. Due to the importance of the capillary force between the nanoscale gaps, the surface of the Li-rGO composite is not covered with thick metallic Li.

FIG. 7. (a) Top and (b) cross sectional SEM images of a bulk CPE used in the evaluation. FIG. 7(a) inset is a digital photo image of the bulk CPE.

FIG. 8. (a) Ionic conductivity of PEG-LiTFSI at different temperatures with varying [EO] to [Li] ratios. (b, c) Photo images of pure PEG and PEG-LiTFSI at varying [EO] to [Li] ratios at room temperature. The liquid-like state of PEG-LiTFSI becomes more stable at room temperature as the concentration of LiTFSI increases. The about 8 to 1 ratio is selected in this evaluation to give a flowable PEG even at room temperature and high ionic conductivity over a wide temperature range.

FIG. 9. Rheological properties of a flowable PEG. Storage modulus (G′) and loss modulus (G″) of the flowable PEG electrolyte measured at about 20° C. and about 100° C.

FIG. 10. Porosity of a 3D porous Li-rGO anode. (a) Porosity of the 3D Li-rGO anode measured by mineral oil absorption, which resulted in a value of about 39 vol. % for electrodes typically used in this evaluation. The weight of the electrode was about 5 mg cm⁻². (b) The weight increase of the 3D Li-rGO anode after flowable PEG electrolyte infiltration (about 200% increase, labeled dot). Given the density of the flowable PEG electrolyte (about 1.2 g cm⁻³), the theoretical weight increase of the electrode with about 39 vol. % porosity if completely infiltrated by the electrolyte is about 150% (labeled dot). In addition, there was also a thin layer of flowable PEG covering the surface of Li-rGO, and thus, the measured value is reasonable.

FIG. 11. Specific capacity of a 3D porous Li-rGO anode. Li stripping curve of the Li-rGO electrodes with two different porosities (about 39 vol. % and about 15 vol. %) in both liquid electrolyte (ethylene carbonate/diethyl carbonate, ECDEC) and solid-state cells with flowable interphase. Higher capacity can be extracted in solid-state cells as the porosity of the Li-rGO increased.

FIG. 12. Cross-sectional SEM images of a 3D porous Li-rGO anode with different thickness. The thickness can be readily tuned by varying the thickness of a starting GO film so as to tune the mass loading of the Li anode.

FIG. 13. Comparison of exchange currents of Li foil and Li-rGO. The difference in exchange current density should be comparable to the difference in electroactive surface area. Exchange current density reflects the intrinsic rate of electron transfer between the electrode and the electrolyte. Under the same electrochemical environment, the intrinsic Li stripping/plating rate should be substantially the same for both Li foil electrode and the 3D Li-rGO electrode. Nevertheless, the electroactive surface area of 3D Li-rGO is much larger than its geometric area, resulting in much greater apparent exchange current density than that of the planar Li foil. The exchange current density of Li-rGO is over about 20 times the value of Li foil. Thus, the electroactive surface area of Li-rGO can be approximated as at least one order of magnitude larger, which can reduce the interfacial fluctuation from tens of microns to submicron scale.

FIG. 14. Focused ion beam (FIB)/SEM images of a Li foil and a 3D Li-rGO electrode after cycling. (a) The Li foil and (b) the 3D Li-rGO electrode after 50 cycles of symmetric cell cycling at a current density of about 0.2 mA cm⁻², a cycling capacity of about 0.2 mAh cm⁻² and a temperature of about 60° C. The surface of the Li foil was porous and rough after cycling, under which dense Li can be observed after FIB milling. On the other hand, after the residual polymer electrolyte on the surface of the Li-rGO electrode was milled away (milling area delineated by dash line), the underlying electrode appeared relatively smooth.

FIG. 15. The effect of a flowable interphase. Voltage profiles of Li foil (labeled), 3D Li-rGO with relatively rigid poly(ethylene glycol) diacrylate (PEGDA) interphase (labeled) and 3D Li-rGO with flowable PEG interphase (labeled) at a current density of about 0.5 mA cm⁻² and a temperature of about 60° C. CPE was used as a bulk solid electrolyte.

FIG. 16. The effect of high surface area Li. Galvanostatic cycling of symmetric cells using 3D Li-rGO with flowable interphase, bare Li foil and Li foil with about 10 μL flowable PEG on the surface at about 60° C. with different current densities. CPE was used as a bulk solid electrolyte.

FIG. 17. Electrochemical impedance evaluation. Nyquist plots of symmetric cells with bare Li foil, Li foil with about 10 μL flowable PEG on the surface and 3D porous Li-rGO electrodes before and after 20 galvanostatic cycles at a current density of about 0.2 mA cm⁻², a cycling capacity of about 0.2 mAh cm⁻² and an operating temperature of about 60° C. CPE was used as a bulk solid electrolyte and measurements were also carried out at about 60° C.

FIG. 18. Symmetric cell voltage profiles at about 80° C. (a) Galvanostatic cycling of symmetric cells using 3D Li-rGO electrodes with flowable interphase and planar Li foil electrodes at about 80° C. with different current densities. The charging and discharging time was fixed at about 1 hour with about 30 min rest in between. (b-e) Detailed voltage profiles at a current density of about 100 μA cm⁻², about 200 μA cm⁻², about 500 μA cm⁻² and about 1 mA cm⁻², respectively (Li foil: outer curves; Li-rGO: inner curves). CPE was used as a bulk solid electrolyte.

FIG. 19. Cycling stability of symmetric cells at about 80° C. Long-term galvanostatic cycling of symmetric cells using 3D Li-rGO electrodes with flowable interphase and planar Li foil electrodes at about 80° C. at a current density of (a) about 0.05 mA cm⁻², (b) about 0.1 mA cm⁻², (c) about 0.2 mA cm⁻² and (d) about 1 mA cm⁻², respectively. The charging and discharging time was fixed at about 1 hour with about 30 min rest in between. (e) Galvanostatic cycling of the symmetric cells at a current density of about 0.5 mA cm⁻² and a cycling capacity of about 1.5 mAh cm⁻². The cells were rested for about 1 hour between each charging and discharging cycle. CPE was used as a bulk solid electrolyte.

FIG. 20. Voltage profiles of Li-LFP full cells after cycling. Galvanostatic charge/discharge voltage profiles of Li-LFP full cells at the 10^{th} and the 100^{th} cycle using (a) Li foil and (b) 3D Li-rGO as the anode at a current density of about 1 mA cm⁻² and an operation temperature of about 60° C. CPE was used as a bulk solid electrolyte.

FIG. 21. Cycling stability of Li-LFP cells at about 80° C. Long-term cycling performance of solid-state Li-LFP batteries using either Li foil or 3D Li-rGO anode at an operation temperature of about 80° C. and a current density of (a) about 0.2 mA cm⁻², (b) about 0.5 mA cm⁻², (c) about 1 mA cm⁻², and (d) about 2 mA cm⁻², respectively. The scattered charge/discharge values of the Li foil cells indicate the occurrence of soft internal short circuits. CPE was used as a bulk solid electrolyte.

FIG. 22. Coulombic efficiency of Li-LFP cells. The Coulombic efficiency data of solid-state Li-LFP batteries using either Li foil or 3D Li-rGO anode cycled at (a) about 1 mA cm⁻² at about 60° C. (corresponding to FIG. 4d) and (B) about 3 mA cm⁻² at about 80° C. (corresponding to FIG. 4h). CPE was used as a bulk solid electrolyte. The Coulombic efficiency of the 3D Li-rGO cells was stable, approaching 100% while the Coulombic efficiency of the Li foil cells was much lower and much more scattered.

FIG. 23. Electrochemical performance of Li-LFP full cells at about 40° C. (a) Rate capability of Li-LFP full cells using either 3D Li-rGO or Li foil as an anode at an operation temperature of about 40° C. (b) Long-term cycling performance of solid-state Li-LFP batteries using either Li foil or 3D Li-rGO anode at an operation temperature of about 40° C. and a current density of about 0.5 mA cm⁻². CPE was used as a bulk solid electrolyte.

FIG. 24. Electrochemical performance of symmetric cells with PEGDA middle layer at room temperature. (a) Ionic conductivity of a crosslinked PEGDA solid electrolyte. (b) Galvanostatic cycling of symmetric cells using 3D Li-rGO electrodes with flowable interphase and planar Li foil electrodes at room temperature using the crosslinked PEGDA as a middle layer. The charging and discharging time was fixed at about 1 hour.

FIG. 25. Characterizations on LLZTO membranes. (a) X-ray diffraction pattern of an as-prepared LLZTO ceramic solid electrolyte membrane and a reference cubic garnet Li₇La₃Zr₂O₁₂ (PDF #00-063-0174). (b) Impedance spectra of an about 400 μm LLZTO membrane at about 25° C. and about 30° C., from which the ionic conductivity value was calculated to be about 3.6×10⁻⁴ and about 4.6×10⁻⁴ S cm⁻¹, respectively.

FIG. 26. Table 1 presenting a comparison of electrochemical performance of a solid-state Li battery using 3D Li with flowable interphase with other designs using a Li foil anode.

FIG. 27. Schematic of a Li battery according to some embodiments.

FIG. 28. Schematic of a composite lithium metal anode according to some embodiments.

### DESCRIPTION

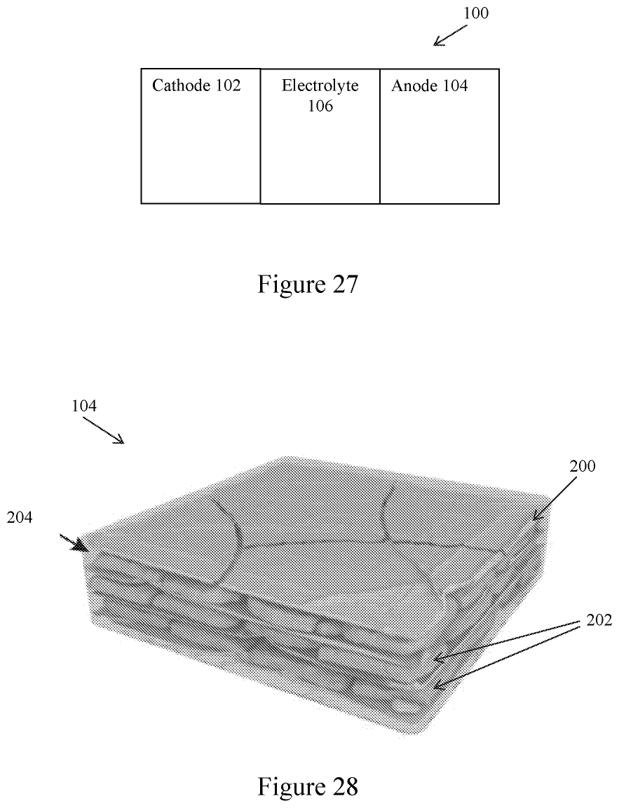

FIG. 27 is a schematic of a Li battery 100 according to some embodiments. The battery 100 includes a cathode 102, an anode 104, and an electrolyte 106 disposed between and in contact with the cathode 102 and the anode 104. In some embodiments, the battery 100 is a lithium-ion battery, and the cathode 102 includes a transition metal oxide as a cathode active material, such as lithium cobalt oxide (LiCoO₂), lithium manganese oxide (LiMn₂O₄), lithium nickel manganese cobalt oxide (LiNiₓMn_{y}Co_{z}O₂), or lithium iron phosphate (LiFePO₄). In some embodiments, the battery 100 is a solid-state Li battery, and the electrolyte 106 is a solid electrolyte, such as a ceramic electrolyte or a solid polymer electrolyte. Other Li batteries are contemplated, such as a lithium-sulfur battery in which the cathode 102 includes sulfur, and a lithium-air battery in which the cathode 102 is a gas cathode.

In some embodiments of the Li battery 100, the anode 104 is a composite lithium metal anode, which, as shown in FIG. 28, includes a porous matrix 200 and lithium metal 202 disposed within pores or other open spaces within the matrix 200. In some embodiments, the porous matrix 200 includes a layered material, such as layered reduced graphene oxide, another carbonaceous layered material or other suitable layered material. Other types of porous matrices are contemplated, such as in the form of foams or meshes, fibrous materials, and porous films, such as formed of a lithium ion (Li⁺) conductive material or another suitable material. In some embodiments, a characterization of the porous matrix 200 is its porosity, which is a measure of the extent of voids resulting from the presence of pores or any other open spaces in the porous matrix 200. A porosity can be represented as a ratio of a volume of voids relative to a total volume, namely between 0 and 1, or as a percentage between 0% and 100%. In some embodiments, the porous matrix 200 can have a porosity that is at least about 0.1 and up to about 0.95 or more, and, more particularly, a porosity can be in the range of about 0.1 to about 0.9, about 0.2 to about 0.9, about 0.3 to about 0.9, about 0.4 to about 0.9, about 0.5 to about 0.9, about 0.5 to about 0.8, or about 0.6 to about 0.8. Techniques for determining porosity include, for example, porosimetry and optical or scanning techniques.

In some embodiments of the Li battery 100, lithium metal 202 is included in the anode 104 as Li domains (e.g., nanosized Li domains) within pores or any other open spaces in the porous matrix 200. In some embodiments, the Li domains have at least one dimension in the range of about 1 nm to about 1000 nm, such as about 900 nm or less, about 800 nm or less, about 700 nm or less, about 600 nm or less, about 500 nm or less, about 400 nm or less, about 300 nm or less, or about 200 nm or less, and down to about 100 nm or less, down to about 50 nm or less, down to about 20 nm or less, or down to about 10 nm or less.

In some embodiments of the Li battery 100, the anode 104 further includes a flowable interphase 204 disposed within pores or other open spaces within the matrix 200, along with lithium metal 202. In some embodiments, the flowable interphase 204 is disposed between Li domains within the porous matrix 200. In some embodiments, the flowable interphase 204 also covers or coats external surfaces of the porous matrix 200.

In some embodiments of the Li battery 100, the flowable interphase 204 includes, or is formed from, a polymer and a plasticizer. In some embodiments, the polymer is a polyether, such as poly(ethylene glycol) or another poly(alkylene glycol). In some embodiments, the plasticizer is a lithium-containing salt, such as bis(trifluoromethane)sulfonimide Li salt, or another Li salt including Li cations and organic or inorganic anions. In some embodiments, a concentration of the lithium-containing salt is such that an ether oxygen to Li molar ratio (or [EO] to [Li] molar ratio) is about 20:1 or less, about 18:1 or less, about 16:1 or less, about 14:1 or less, about 12:1 or less, about 10:1 or less, or about 8:1 or less, and down to about 6:1 or less, or about 4:1 or less. In some embodiments, the flowable interphase 204 is a viscous gel at a battery operating temperature or a battery operating temperature range, such as about 20° C. to about 100° C., about 25° C., or about 40° C.

In some embodiments of the Li battery 100, the flowable interphase 204 has a complex viscosity at about 10 Hz of about 100 Pa·s or less at about 20° C., such as about 90 Pa·s or less, about 80 Pa·s or less, about 70 Pa·s or less, or about 60 Pa·s or less, and down to about 40 Pa·s or less, or down to about 20 Pa·s or less. In some embodiments, the flowable interphase 204 has a complex viscosity at about 10 Hz of about 60 Pa·s or less at about 40° C., such as about 50 Pa·s or less, about 40 Pa·s or less, about 30 Pa·s or less, or about 20 Pa·s or less, and down to about 10 Pa·s or less, or down to about 5 Pa·s or less. In some embodiments, the flowable interphase 204 has an ionic conductivity (with respect to Li⁺ions) of at least about 10⁻⁷ S cm⁻¹ at about 40° C., such as at least about 10⁻⁶ S cm⁻¹, at least about 10⁻⁵ S cm⁻¹, or at least about 10⁻⁴ S cm⁻¹, and up to about 10⁻³ S cm⁻¹ or greater, or up to about 10⁻² S cm⁻¹ or greater.

In some embodiments of the Li battery 100, the flowable interphase 204 is at least primarily amorphous by weight or volume, such as at least about 51%, at least about 55%, at least about 60%, at least about 70%, or at least about 80%.

In some embodiments of the Li battery 100, the anode 104 is formed as a composite lithium metal anode, by a manufacturing method including providing the porous matrix 200, providing liquefied or molten Li metal (e.g., in a state at or above the melting point of Li of about 180° C.), and infusing or infiltrating the liquefied Li metal into the porous matrix 200. In some embodiments, the porous matrix 200 is intrinsically lithiophilic or is rendered or otherwise treated to become lithiophilic, so as to facilitate infusing of lithium metal 202 into the porous matrix 200. Lithiophilicity or lithiophilic nature of a material refers to an affinity of the material towards lithium metal 202, such as in its liquefied or molten state. In some embodiments, lithiophilic nature of a material can be characterized according to wettability of a solid surface of the material by liquefied or molten Li metal. A measure of wettability is a contact angle between the solid surface and a drop of liquefied Li metal disposed on the surface, where the contact angle is the angle at which the liquid-vapor interface intersects the solid-liquid interface. As the tendency of the liquefied Li metal to spread over the solid surface increases, the contact angle decreases. Conversely, as the tendency of the liquefied Li metal to spread over the solid surface decreases, the contact angle increases. Contact angles less than 90° (low contact angles) typically indicate that wetting of the solid surface is favorable (high wetting), while contact angles greater than or equal 90° (high contact angles) typically indicate that wetting of the surface is unfavorable (low wetting). In some embodiments, the porous matrix 200 is or is rendered lithiophilic so as to form a contact angle with liquefied Li metal of less than 90° , such as about 89° or less, about 87° or less, about 85° or less, about 80° or less, about 75° or less, about 70° or less, about 65° or less, about 60° or less, or about 50° or less, and down to about 30° or less, down to about 20° or less, or down to about 10° or less.

In some embodiments of the Li battery 100, the manufacturing method further includes providing a composition as a liquefied flowable interphase, and infusing or infiltrating the composition into the porous matrix 200 to form the flowable interphase 204.

Other embodiments of the Li battery 100 are contemplated, such as in which the cathode 102 includes a porous matrix, and also includes a cathode active material and a flowable interphase disposed within pores or other open spaces within the matrix.

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

Transforming from planar to three-dimensional lithium with flowable interphase for solid lithium metal batteries

### Overview

Solid-state lithium (Li) metal batteries are prominent for next-generation energy storage technology due to their much higher energy density with reduced safety risk. Solid electrolytes have been intensively studied and several materials with high ionic conductivity have been identified. However, there are still at least three obstacles prior to making Li metal foil-based solid-state systems viable, namely, high interfacial resistance at Li/electrolyte interface, low areal capacity and poor power output. Here, this example addresses these obstacles by incorporating a flowable interfacial layer and three-dimensional Li into the system. The flowable interfacial layer can accommodate the interfacial fluctuation and ensure excellent adhesion, while the three-dimensional Li significantly reduces the interfacial fluctuation from the whole electrode level (e.g., tens of micron) to local scale (e.g., submicron), and also decreases an effective current density for facilitating a charge transfer process and allowing for high capacity and high power operation. The flowable interfacial layer (or electrolyte interphase) can provide a substantially continuous ion percolation pathway throughout the Li metal and ionically connect an anode to a bulk solid electrolyte. In addition, the flowable interphase can continuously adjust its conformation during cycling to maintain an excellent electrode-electrolyte contact. As a consequence, both symmetric and full-cell configurations can achieve greatly improved electrochemical performance compared to other Li foil counterparts. Noticeably, solid-state full cells paired with LiFePO₄ exhibited at about 80° C. a high specific capacity even at about 5 C rate (about 110 mAh g⁻¹) and about 93.6% capacity retention after 300 cycles at a current density of about 3 mA cm⁻² using a composite solid electrolyte middle layer. And when a ceramic electrolyte middle layer was adopted, stable cycling with further improved specific capacity can even be realized at room temperature.

### Introduction

Here, this example presents a paradigm shift on the structural design of solid-state Li batteries: different from other strategies where cells are constructed using a planar Li foil, this example adopts a three-dimensional (3D) Li anode with high electroactive surface area. Moreover, the challenge of creating a conformal and continuous ionic contact between the 3D Li anode and a bulk solid electrolyte is successfully addressed via a flowable ion-conducting interphase. Specifically, metallic Li in layered reduced graphene oxide host (Li-rGO) is used as the anode, and poly(ethylene glycol) (PEG, M_{w} of about 10,000) plasticized by bis(trifluoromethane)sulfonimide Li salt (LiTFSI), which resembles a viscous semi-liquid, is impregnated into the 3D Li-rGO via thermal infiltration to construct the flowable interphase. This structural design has several major advantages: First, the adoption of a 3D Li anode significantly increases the electrode-electrolyte contact area, dissipating the current density to facilitate charge transfer and offering opportunities for high power operation. Second, by dividing bulk Li into small domains, the interfacial fluctuation during cycling can be reduced to submicron scale, allowing cells to be cycled at much higher capacity. Importantly, the incorporation of a flowable interfacial layer can accommodate the varying morphology at the 3D Li anode surface during cycling, which is desirable for maintaining a continuous electrode-electrolyte contact. Finally, the 3D Li anode design can be adopted as a general approach in solid-state Li batteries, which are compatible with both SPEs and inorganic ceramic electrolytes, and provide all-solid cells omitting flammable plasticizers. With the above merits, the innovative design allows the construction of solid-state Li cells with outstanding electrochemical behavior in terms of overpotential and stability in both symmetric and full-cell configurations over a wide range of operating temperatures (e.g., room temperature to about 80° C.). When paired with high mass loading LiFePO₄ (LFP) cathode and a composite polymer electrolyte (CPE), cells using Li-rGO anode demonstrated excellent rate capabilities (e.g., about 141 mAh g⁻¹ and about 110 mAh g⁻¹ for about 1 C and about 5 C respectively at about 80° C.) and cycle life (e.g., about 93.6% capacity retention after 300 cycles at about 80° C. with a current density of about 3 mA cm⁻²), while the Li foil counterparts have diminished performance (about 120 mAh g⁻¹ and about 60 mAh g⁻¹ for about 1 C and about 5 C respectively at about 80° C.; about 46% capacity retention after 300 cycles with a current density of about 3 mA cm⁻²). In addition, stable room temperature cycling is also realized in combination with garnet-type ceramic electrolyte. Therefore, this 3D Li anode with flowable interphase can shed light on an improved architectural design of solid Li metal batteries and even better cell performance can be realized when paired with an advanced bulk solid electrolyte.

### Design Strategy of the 3D Li Metal Anode with Flowable Interphase

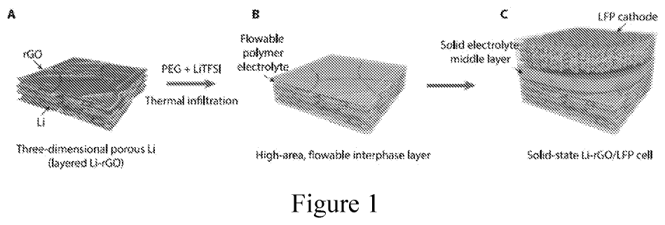

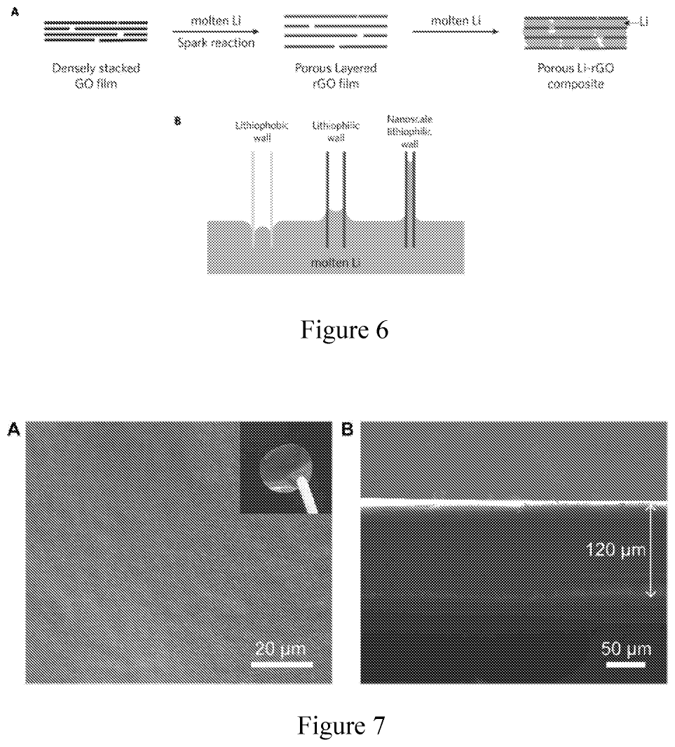

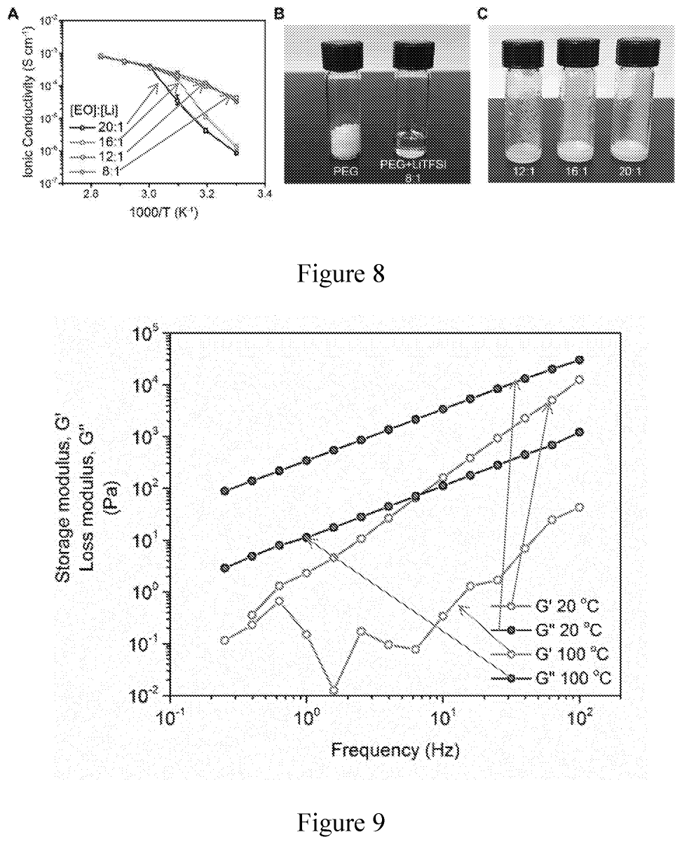

FIG. 1 schematically shows a fabrication process of solid Li metal cells based on the improved anode design. Metallic Li with a thickness of several hundred nanometers can be uniformly stored in between rGO flakes (FIG. 1a). Specifically, when densely stacked layered GO film obtained by vacuum filtration is put into contact with molten Li, a “spark reaction” can occur rapidly, expanding the film into a porous structure (FIG. 6a). This can be explained by the sudden pressure release of the superheated residual water molecules within the GO layers and the combustion of hydrogen produced from the partial reduction of the oxygen-containing surface functional groups. Subsequently, when the edge of the sparked film is placed in molten Li, Li can infuse into the rGO host rapidly and homogeneously. The mechanism of the molten Li infusion is explained schematically in FIG. 6b. The strong interaction between molten Li and the remaining surface functional groups on rGO make the rGO surface lithiophilic (e.g., good molten Li wettability). The capillary force on a good wetting surface will raise the liquid level and the height of the liquid level is inversely proportional to the dimension of the gaps. Therefore, the nanoscale gaps between the rGO layers can provide strong capillary force to drive the molten Li intake into the rGO host. The advantages of the resulting Li-rGO composite structure include suppressed dendrite formation, largely increased electroactive surface area, enhanced cycling efficiency and reduced volume change during cycling.

Notably, to construct solid-state cells based on 3D Li, an effective strategy to form continuous ionic percolation throughout the nanosized pores is desired, which is a challenging task. The highly reactive nature of Li metal with organic solvents severely restricts the possibilities for solution-based solid electrolyte impregnation. However it remains a great technical challenge to realize conformal solid electrolyte coating on 3D Li via gas-phase deposition at temperatures below the melting point of Li (about 180.5° C.). Accordingly, it is proposed to thermally infiltrate a short-chain polymer electrolyte into Li-rGO, which is specifically engineered to be flowable over a wide range of operating temperatures to ensure an intimate ionic contact (FIG. 1b). The properties of the flowable interphase layer will be described in greater detail in the following section.

After the construction of the high-area flowable interphase layer, as a proof-of-concept, a mechanically strong CPE (FIG. 7) or a cubic garnet-type Li₆₅La₃Zr_{0.5}Ta_{1.5}O₁₂ (LLZTO) ceramic electrolyte was adopted as the bulk solid electrolyte middle layer. Specifically, the CPE is composed of long-chain poly(ethylene oxide) (PEO, M_{w} of about 300,000), LiTFSI and fumed silica nanoparticles. The introduction of the fumed silica nanoparticles in the CPE has the following functionalities: (1) the nanoparticles serve as cross-linking centers to reduce the crystallinity of PEO, facilitating the segmental motions of the polymer chains to increase the ionic conductivity; (2) the strong Lewis acid-base interaction between the surface chemical groups of the fumed silica nanoparticles (Lewis acid) and the Li salt anions (Lewis base) can promote salt dissociation, which also increases the ionic conductivity; and (3) the rigid silica fillers can enhance the mechanical property of the polymer electrolyte. Therefore, such structural design is also advantageous in the sense that the two conflicting criteria for solid electrolytes, namely, high mechanical property (solid electrolyte middle layer) and good interfacial adhesion (flowable interphase layer) can be successfully decoupled. Finally, a high-mass loading LFP cathode using the same CPE as a binder was overlaid to form the final full cell (FIG. 1c).

### Materials Characterizations

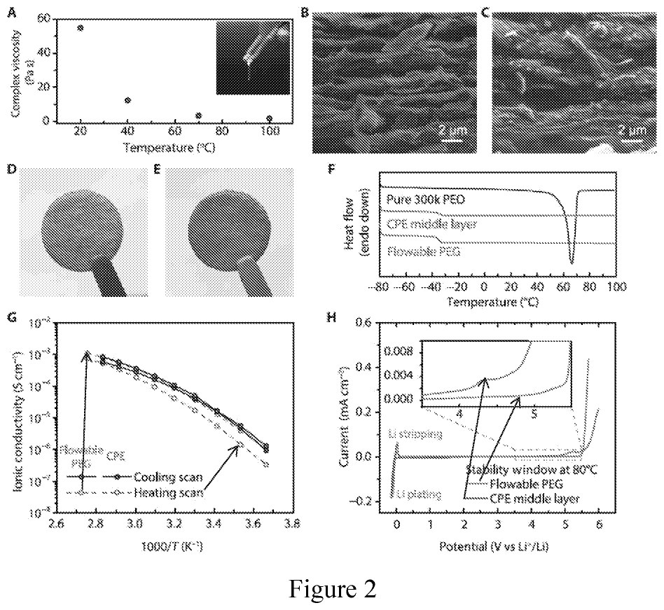

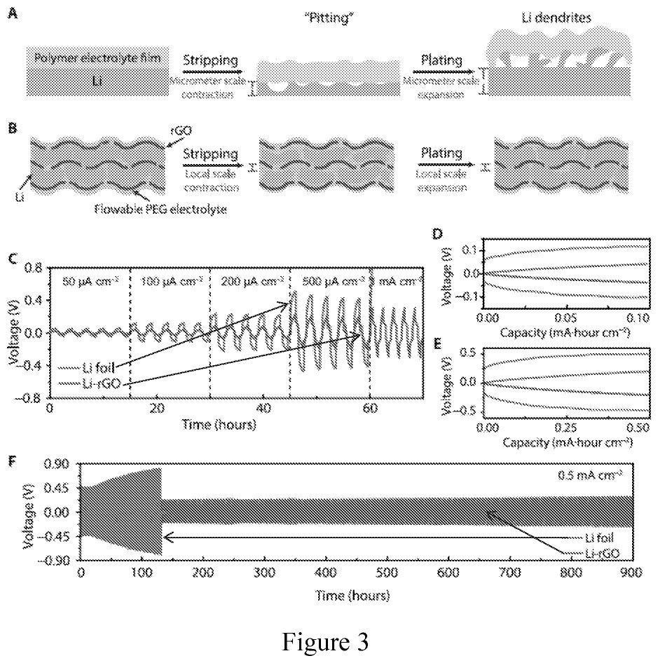

FIG. 2a shows rheological properties of the flowable PEG polymer electrolyte. Although pure PEG is a semi-crystalline solid at room temperature, crystallization can be effectively suppressed in the presence of LiTFSI salt (FIG. 3). The stability of the liquid-like PEG polymer electrolyte increases with increasing salt concentration, and when the [EO] (or ether oxygen) to [Li] molar ratio reached about 8 to 1, a viscous gel can be maintained even at room temperature. The complex viscosity of the flowable PEG was measured to be about 55 Pa·s at about 20° C. but decreased to just about 1.8 Pa·s when heated to about 100° C.; the viscosity can be even lower at the actual thermal infiltration temperature, which is a value beyond the measurement limit of the instrument used. Moreover, the loss modulus was higher than the storage modulus at all measured temperatures, indicating the liquid-like behavior of the flowable PEG (FIG. 9). The relatively high viscosity at low temperatures imparts the PEG polymer electrolyte reduced mobility to diffuse into the bulk solid electrolyte middle layer during operations. Yet, the good fluidity at elevated temperatures makes it favorable for thermal polymer infiltration into the 3D Li-rGO anode. Scanning electron microscopy (SEM) was utilized to assess the microstructures of the 3D Li-rGO electrode before and after thermal infiltration of the flowable PEG at about 150° C. As shown in FIG. 2b, the pristine Li-rGO anode exhibited uniform stacking of nanoscale Li and layered rGO with high porosity. After flowable PEG infiltration, it is evident that the polymer electrolyte substantially completely occupied the nanoscale pores of Li-rGO (FIG. 2c). This difference can also be observed visually, as the Li-rGO electrode appeared darker in color after thermal infiltration due to the filling of the nanopores (FIG. 2d, e).

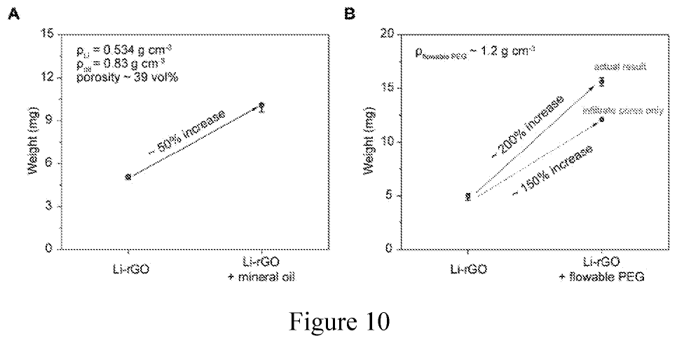

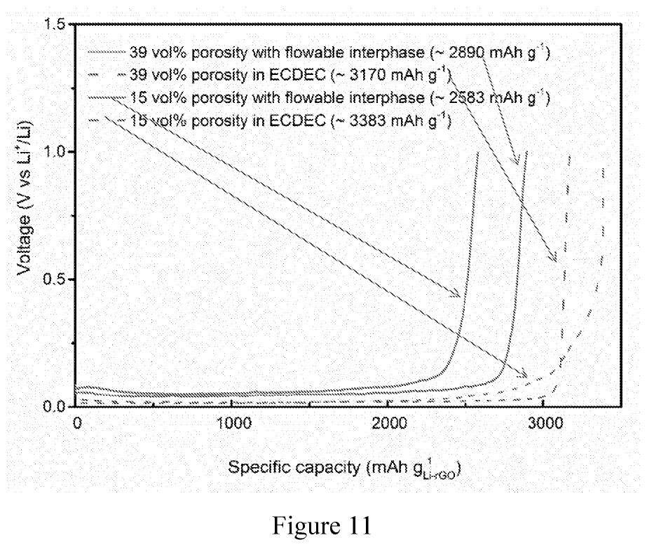

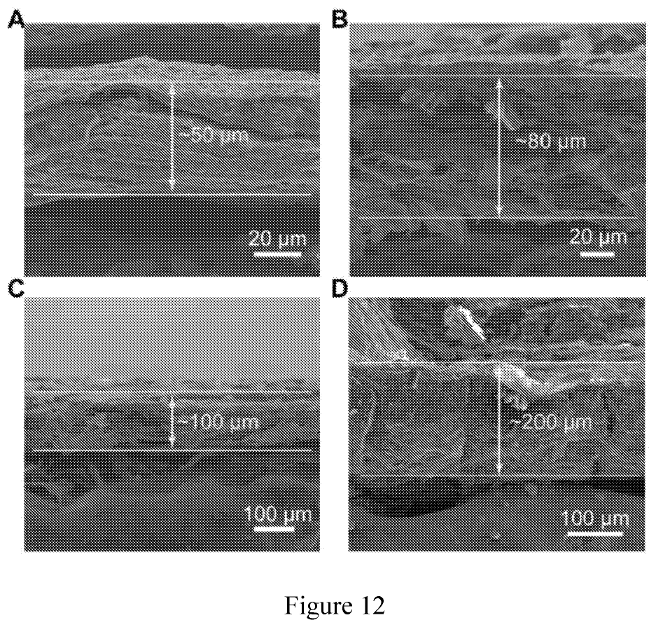

The porosity of the 3D Li-rGO electrode used in the evaluation was measured to be about 39 vol. % via mineral oil absorption test (FIG. 10a). The subsequent infiltration of flowable PEG resulted in on average about 200% increase in the total weight of the composite electrode (FIG. 10b, labeled dot). Given the density of the flowable PEG electrolyte (about 1.2 g cm⁻³), the theoretical weight increase of the electrode with about 39 vol. % porosity, if completely infiltrated by the electrolyte, is about 150% (labeled dot). In addition, there was also a thin layer of flowable PEG covering the surface of Li-rGO; thus, the measured value is reasonable. The specific capacity of the 3D Li-rGO electrode with flowable interphase was determined by stripping the electrode to about 1 V versus Li⁺/Li in a solid-state cell and comparing with the value in liquid electrolyte (about 1 M LiPF₆ in about 1/1 ethylene carbonate/diethyl carbonate, FIG. 11). For Li-rGO with about 39 vol. % porosity, the specific capacity in liquid electrolyte was about 3170 mAh g⁻¹, and when integrated into a solid-state cell with flowable interphase, a high extractable capacity of about 2890 mAh g⁻¹ can be retained. This indicates the effectiveness of the flowable interphase in maintaining the ionic contact between the 3D electrode and the bulk solid electrolyte during Li stripping. On the other hand, if the porosity of the Li-rGO electrode was reduced to about 15 vol. % (by reducing the residual water content in the starting GO film), less capacity can be extracted in the solid-state cell (about 2583 mAh g⁻¹) together with increased stripping overpotential. Therefore, high Li-rGO porosity is desirable to increase the electrode-electrolyte contact area for better electrochemical performance.

The crystallinity of the polymer electrolyte was further characterized using differential scanning calorimetry (DSC) analysis (FIG. 2f). The absence of endothermic melting peaks in DSC reveals that both the flowable PEG and the CPE middle layer used in this evaluation possessed an amorphous structure, which is desired for realizing high ionic conductivity. Correspondingly, their ionic conductivity obtained from the Nyquist plots of electrochemical impedance tests can reach the order of about 10⁻⁴ S cm⁻¹ at about 40° C. (FIG. 2g), allowing the operation of solid-state Li cells at slightly elevated temperature (e.g., human body temperature for wearables). Finally, the electrochemical stability window of the solid electrolytes was evaluated at about 80° C. via cyclic voltammetry (CV). As can be seen from FIG. 2h, the flowable PEG can be stable up to at least about 5 V versus Li⁺/Li, and the CPE middle layer also demonstrated negligible anodic decomposition at the potential of the LFP cathode used in the evaluation. And the excellent compatibility with Li metal makes the PEG electrolyte a desirable choice for the buffer layer, interfacing the 3D Li anode and the solid electrolyte middle layer with little or no blocking of Li-ion transport.

### Electrochemical Testing with Symmetric Cell Configuration

To demonstrate the advantages of the 3D Li-rGO anode with flowable interphase, electrochemical characterizations in symmetric cell configuration with CPE middle layer were carried out and compared with a Li foil counterpart. The thickness of the 3D Li-rGO used was about 100-150 μm and the value can be readily tuned by changing the thickness of the rGO host to vary the mass loading of the anode (FIG. 12); the thickness of the reference Li foil was about 750 The mass of the 3D Li-rGO electrode was about 4 to 5 mg cm⁻², given the measured specific capacity of the electrode discussed above (FIG. 11; about 2890 mA·hour g⁻based on the weight of Li-rGO), and the areal mass loading of the 3D Li-rGO anode used in this evaluation was about 12 to 14 mA·hour cm⁻².

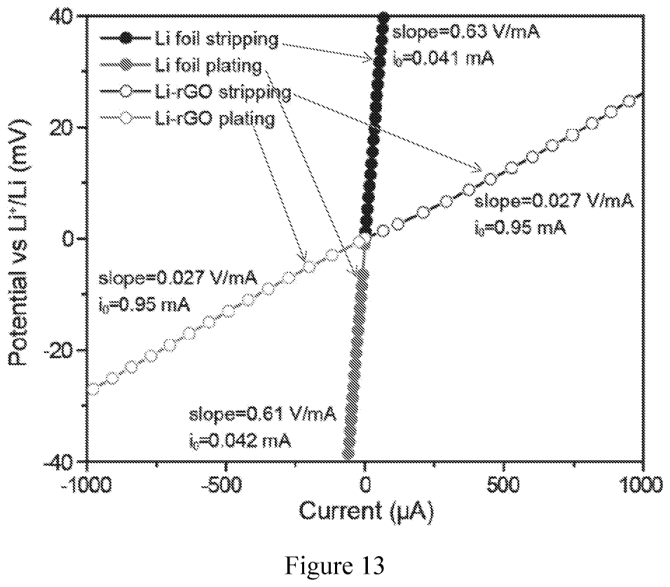

For planar Li foil, the large volume change during cycling and the uneven Li plating/stripping make it difficult to maintain a continuous adhesive contact with the CPE (FIG. 3a). The solid electrolyte delamination will increase the interfacial resistance of the cells during cycling, resulting in augmenting overpotential. While for the improved anode design, a much lesser degree of interfacial fluctuation can occur due to the high surface area (interfacial fluctuation can be reduced to submicron scale, as calculated from the exchange current density, FIG. 13), and the fluidic PEG interphase layer can also continuously adjust its conformation during cycling, both of which are beneficial to afford an intimate electrode-electrolyte contact (FIG. 3b). In addition, the high surface area Li can also effectively dissipate the local current density to reduce the charge transfer resistance. It is postulated that when Li is stripped from the inside of 3D Li-rGO, the flowable interphase can partially fill empty spaces left behind and therefore maintain the ionic contact between the anode surface and the solid electrolyte. During subsequent Li deposition, Li metal can displace the flowable interphase due to the softness of this polymer electrolyte layer and deposit back into the 3D porous electrode. Because not all of the Li is stripped away, the remaining Li inside the Li-rGO can provide a strong driving force for Li to be deposited back into the electrode due to a much lower Li nucleation barrier on the Li surface.

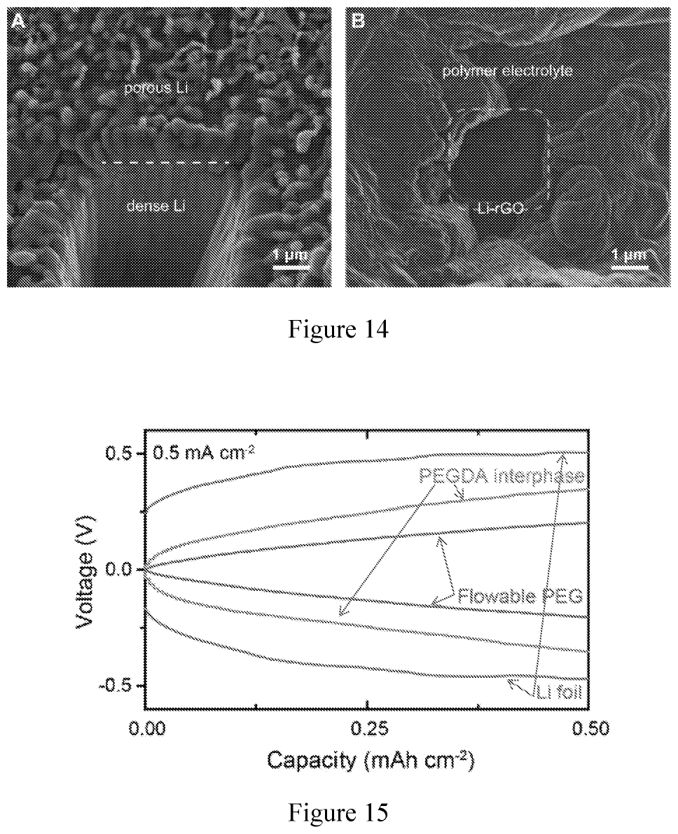

Correspondingly, as can be seen in FIG. 3c, the Li-rGO symmetric cells consistently showed a much smaller Li stripping/plating polarization compared to the Li foil cells at about 60° C. Noticeably, Li foil cannot be operated at a current density of about 1 mA cm⁻² due to interphase delamination (overpotential increased to above about 5 V) while the Li-rGO cells still exhibited stable voltage profiles. At a current density of about 0.1 mA cm⁻² (FIG. 3d), the average overpotential for Li-rGO cells was about 24 mV, which is about one fourth the value of Li foil cells (about 95 mV). The advantages became more noticeable at higher current densities; for example, when cycled at a current density of about 0.5 mA cm⁻², the average overpotential of the Li foil cells was as high as about 425 mV while the value for Li-rGO cells was about 125 mV (FIG. 3e). Moreover, the 3D Li-rGO anode with flowable interphase also greatly outperformed the Li foil in terms of cycling stability. As shown in FIG. 3f, the Li-rGO symmetric cells exhibited stable cycling for at least 300 cycles (about 900 hours) at a current density of about 0.5 mA cm⁻² and no observable dendrites can be found on the surface of the Li-rGO electrode after cycling (FIG. 14). On the other hand, at the same current density, the Li foil cells showed gradual increase in voltage hysteresis over cycles due to the accumulating interfacial impedance, followed by internal short circuit within 43 cycles.

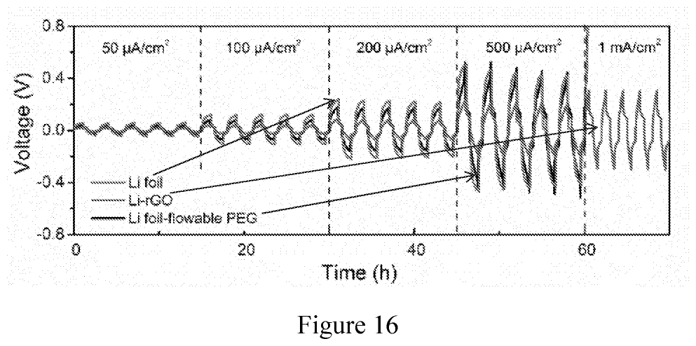

To account for the improved electrochemical performance, separate experiments were further designed to elucidate the contributions of both the flowable PEG interphase and the high surface area 3D Li-rGO anode. To demonstrate the importance of having a flowable interfacial layer to continuously adjust its conformation during cycling, flowable PEG was replaced with a relatively rigid crosslinked polymer electrolyte interphase. This crosslinked interphase was obtained by infiltrating an electrolyte precursor composed of about 6:4:8 (weight ratio) poly(ethylene glycol) diacrylate (PEGDA, M_{w} of about 700, with about 1 wt. % CIBA IRGACURE 819/succinonitrile (as a plasticizer)/LiTF SI into the 3D Li-rGO electrode followed by photo-curing under about 360 nm ultraviolet light. As shown in FIG. 15, 3D Li-rGO with crosslinked PEGDA interphase exhibited a higher Li stripping/plating overpotential compared to that with flowable PEG interphase, which confirms that an adaptable interfacial layer is desired in improving the electrode-electrolyte contact in solid-state cells. Secondly, symmetric cell cycling was also performed using planar Li foil electrodes with about 10 μL flowable PEG covered on the surface (Li foil-flowable PEG, FIG. 16). To some degree, the presence of the flowable PEG improved the adhesion between the Li foil and the solid electrolyte middle layer, such that a slightly reduced overpotential can be achieved at low current densities. Nevertheless, the performance remained much inferior to that of 3D Li-rGO with flowable interphase. Therefore, it is evident that the combination of 3D Li and the flowable interphase is desired to achieve improved electrochemical performance.

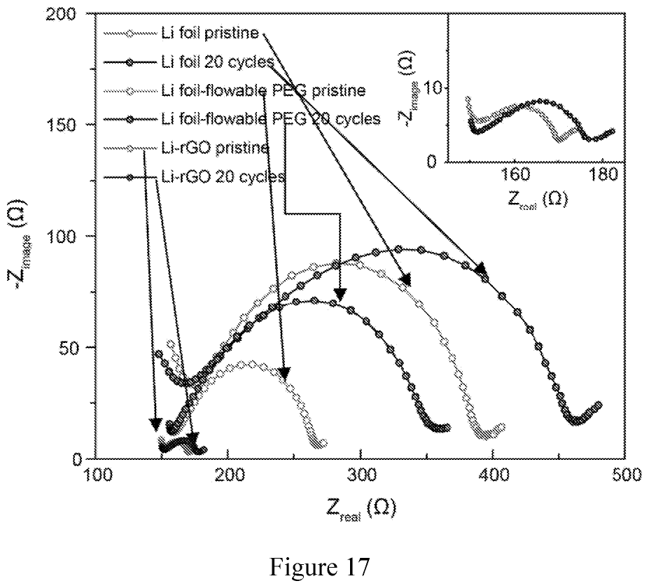

To corroborate the abovementioned points, the interfacial resistance of the symmetric cells was further evaluated employing electrochemical impedance spectroscopy (FIG. 17). The partial semicircle at high frequency of the Nyquist plot represents the resistance of the CPE layer while the large semicircle at medium and low frequency corresponds to the interfacial resistance (Rᵢ). At about 60° C., the R₁ of the Li foil symmetric cell was about 221 ohm cm², and increased to about 300 ohm cm² after 20 galvanostatic cycles at a current density of about 0.2 mA cm⁻² and a capacity of about 0.2 mAh cm⁻², indicating the rapidly deteriorating electrode-electrolyte contact during cycling. With a thin flowable PEG layer to improve adhesion, the R₁ could be reduced to about 108 ohm cm²; yet the value doubled (about 205 ohm cm²) after 20 cycles due to the micron scale Li stripping/plating volume change that could hardly be accommodated by the thin flowable layer. The 3D Li-rGO cell with flowable interphase exhibited a R, value of about 18 ohm cm², which is one order of magnitude smaller than the Li foil cells. The result is consistent with the exchange current density measurements, where the electroactive surface area of the 3D Li-rGO electrode was approximated as at least one order of magnitude larger. The increase in interfacial resistance was minimal after cycling (about 24 ohm cm²), establishing the stability of the interphase between 3D Li-rGO and flowable PEG.

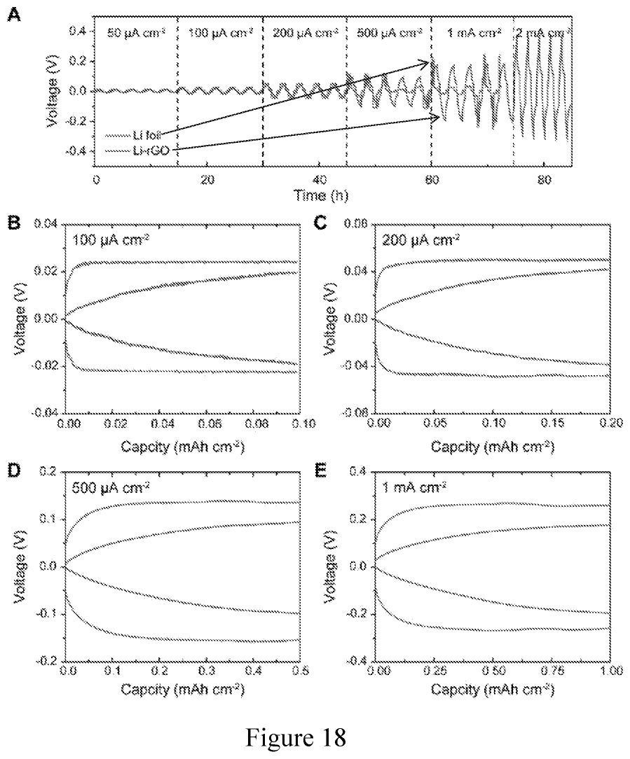

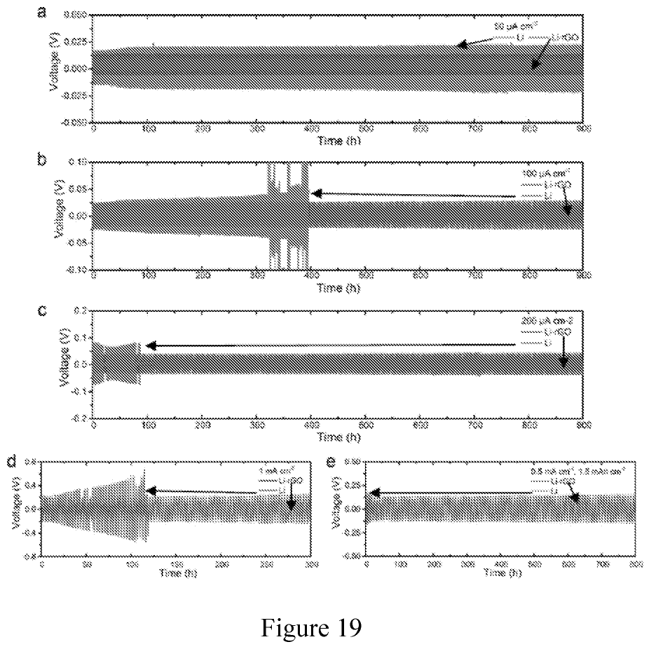

When the operating temperature was further increased to about 80° C., the Li stripping/plating overpotential of the Li foil cells improved due to both the increased ionic conductivity and the softening of the CPE middle layer, which is beneficial for adhesive interfacial contact (FIG. 18). However, the reduced mechanical property of the CPE layer also made the Li foil cells more prone to internal short circuit (the Li foil cell shorted at about 0.5 mA cm⁻²). Nevertheless, the improved 3D Li cells still excelled in overpotential and long-term stability (FIGS. 18 and 19). Noticeably, different from the low current density cycling in other designs, the Li-rGO cells can be cycled at a high current density of at least about 2 mA cm⁻². More than 900 hours of stable Li stripping/plating with little overpotential increase can be realized at various current densities and cycling capacities (demonstrated up to about 1.5 mAh cm⁻² cycling capacity). Such notably improved electrochemical performance compared to that of planar Li foil, especially at high current densities and capacities, justifies the effectiveness of employing 3D Li anode with flowable interphase for high-performance solid-state Li batteries.

### Solid-State Li-LFP Cells with CPE Middle Layer

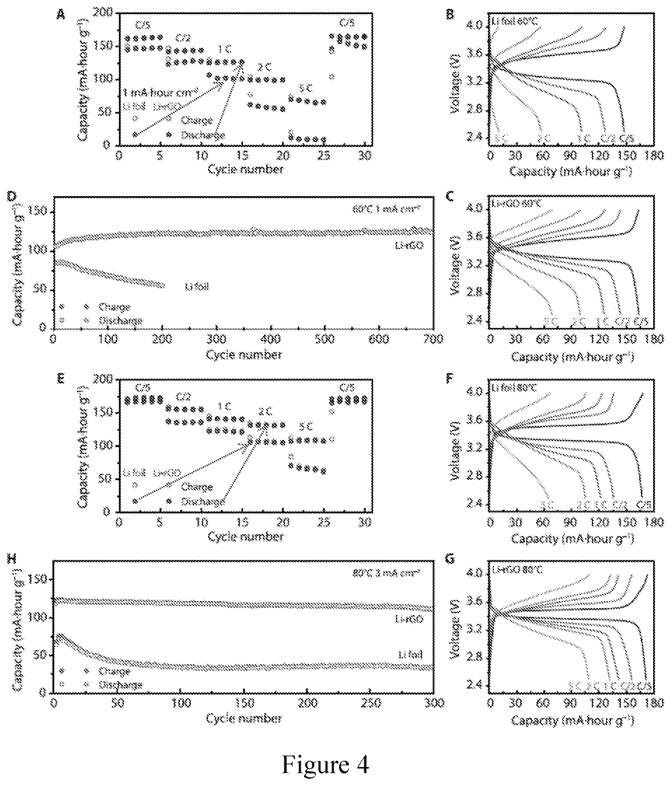

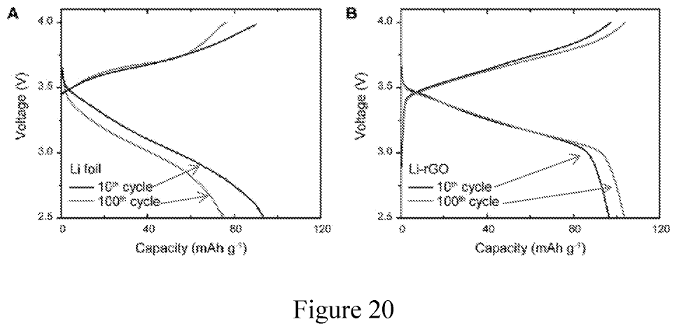

To demonstrate the feasibility of the improved 3D Li anode design for solid-state Li battery, full cells pairing with LFP cathode and CPE middle layer were first assembled to carefully examine the rate capability and long-term cycling stability. Notably, different from other solid Li batteries where the cathode mass loading is kept low to minimize the interfacial delamination, a relatively high capacity cathode (about 1 mAh cm⁻²) was employed here to highlight the effectiveness of the design strategy towards improving the interfacial contact. As can be seen from FIG. 4a, it is apparent that a full cell using the 3D Li-rGO anode demonstrated much better rate performance compared to the Li foil counterpart at about 60° C. At relatively low current densities, the specific discharge capacity of the Li foil cell was about 147, about 127 and about 101 mAh g⁻¹ at about 0.2 C, about 0.5 C and about 1 C respectively (FIG. 4b), whereas the values of the 3D Li-rGO cell can be as high as about 164, about 144 and about 126 mAh g⁻¹ at about 0.2 C, about 0.5 C and about 1 C respectively (FIG. 4c). The discrepancy was even larger at increased current densities. The discharge capacity of the Li foil cell dropped to about 57 mAh g⁻¹ at about 2 C and to merely about 10 mAh g⁻⁻¹ at about 5 C due to the reduced electroactive surface area, while decent capacities can still be retained for the Li-rGO cell (about 100 and about 70 mAh g⁻⁻¹ at about 2 C and about 5 C respectively), which is desired for advanced applications. With regard to the long-term cycling stability, over 700 charge/discharge cycles can be achieved using the 3D Li-rGO anode with little or no degradation (FIG. 4d), while the capacity of the Li foil cell decayed rapidly with 200 cycles due to the incrementing interfacial impedance reflected from the more polarized voltage profiles (FIG. 20).

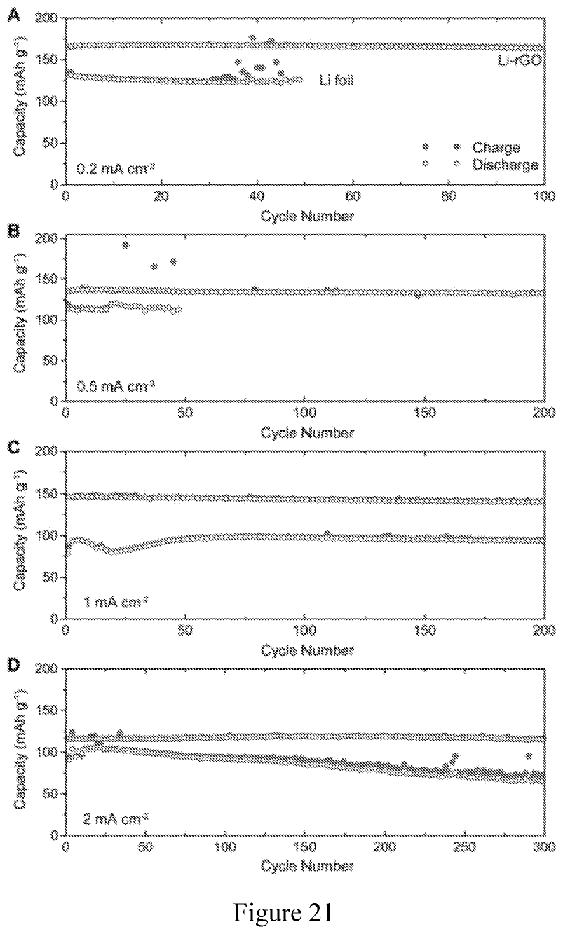

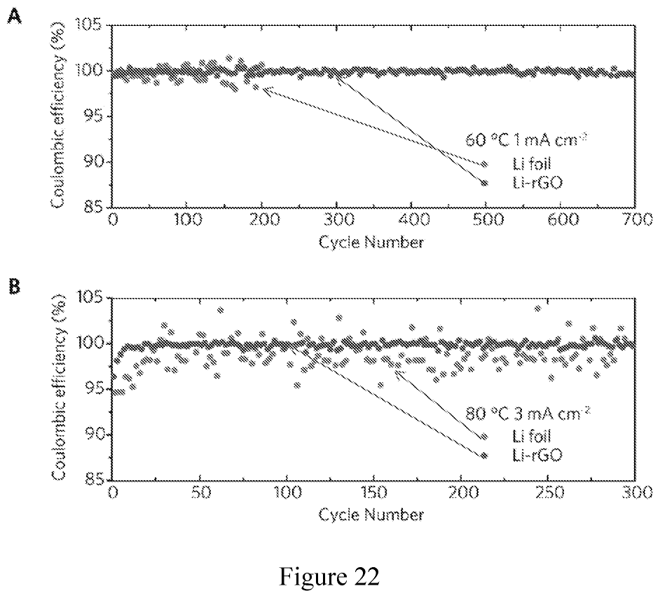

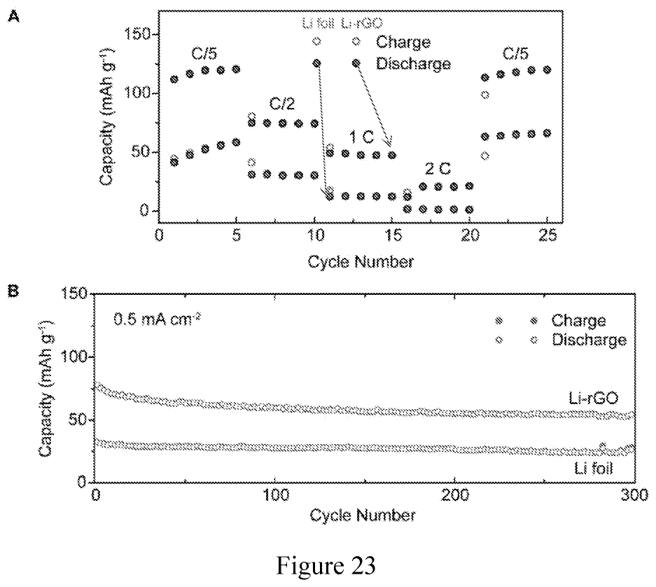

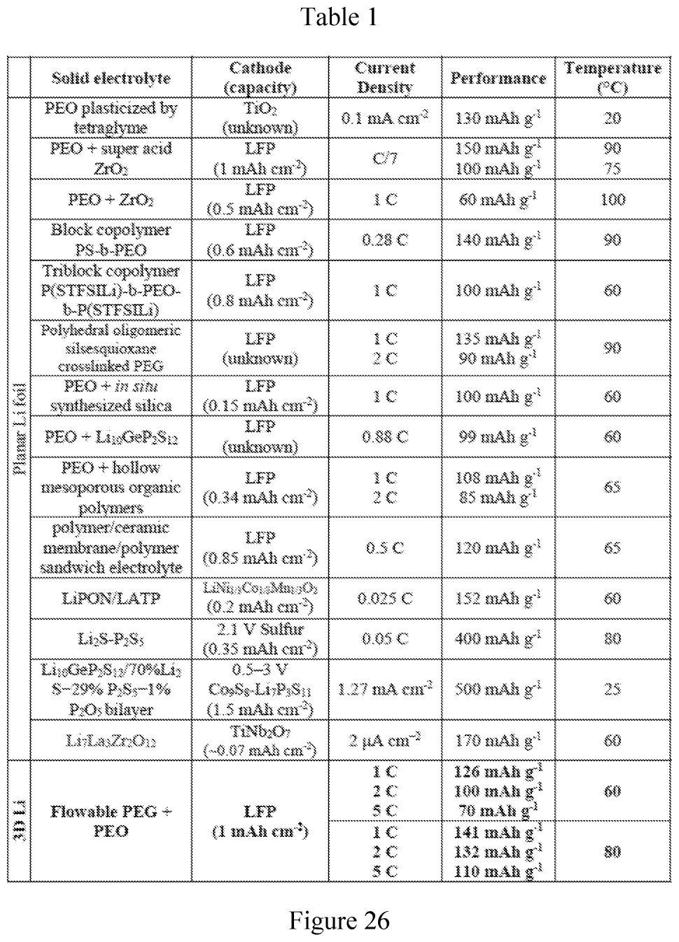

The 3D Li-rGO full cells with flowable interphase presented even better performance at about 80° C. The cells can deliver capacities of about 170, about 156, about 141, about 132 and about 110 mAh g⁻¹ at varied rates of about 0.2 C, about 0.5 C, about 1 C, about 2 C and about 5 C, respectively, which were much better than cells using Li foil anode (FIG. 4e-g). Notably, long-term cycling at a high current density of about 3 mA cm⁻² can deliver an initial discharge capacity of about 125 mAh g⁻¹ with about 93.6% capacity retention after 300 cycles (about 117 mAh g⁻¹), while the Li foil counterpart preserved about 46% of its initial capacity (about 72 mAh g⁻¹) after 300 cycles (FIG. 4h). Superior cycling stability was also demonstrated at other current densities (FIG. 21). The Coulombic efficiency data of the LFP cells corresponding to FIG. 4 (d and h) are provided in FIG. 22. It is evident that the Coulombic efficiency of the 3D Li-rGO cells demonstrated very stable Coulombic efficiency during cycling with values approaching 100%, whereas the values of Li foil cells were much lower and much more scattered. Finally, full cells operating at lower temperature is also possible using the 3D Li-rGO anode, while the Li foil cells barely showed any capacity (about 40° C., FIG. 23). The full cell performance in this evaluation takes into account both the cycling capacity and the current density (Table 1 in FIG. 26, which presents a comparison of electrochemical performance of the solid-state Li battery using 3D Li with flowable interphase with other designs using Li foil anode). The remarkable electrochemical data is a strong indicator of the superior interfacial properties using the 3D Li-rGO anode with flowable interphase.

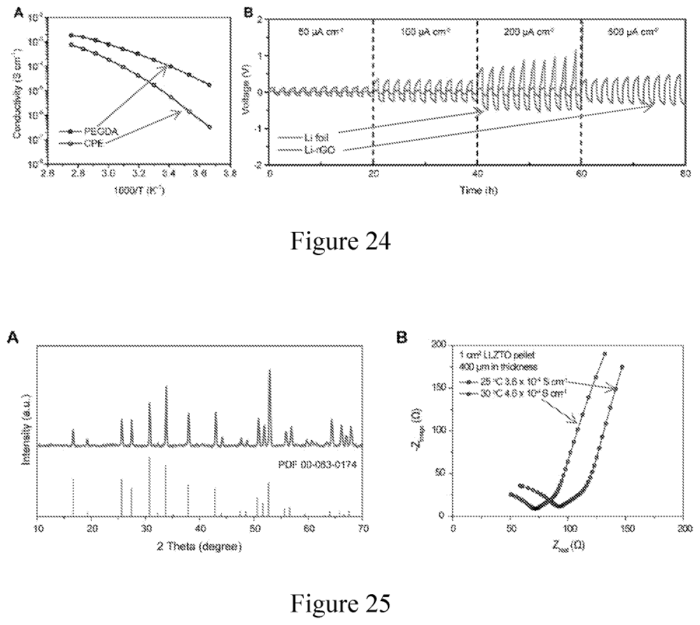

At lower temperatures, the electrochemical performance is mainly restricted by the ionic conductivity of the CPE middle layer. To demonstrate the point, the CPE middle layer is replaced by crosslinked PEGDA electrolyte, whose ionic conductivity is higher at room temperature. As a result, stable cycling can be successfully demonstrated at room temperature with much reduced overpotential than the Li foil counterpart (FIG. 24).

### Solid-State Li-LFP Cells with Ceramic Electrolyte Middle Layer

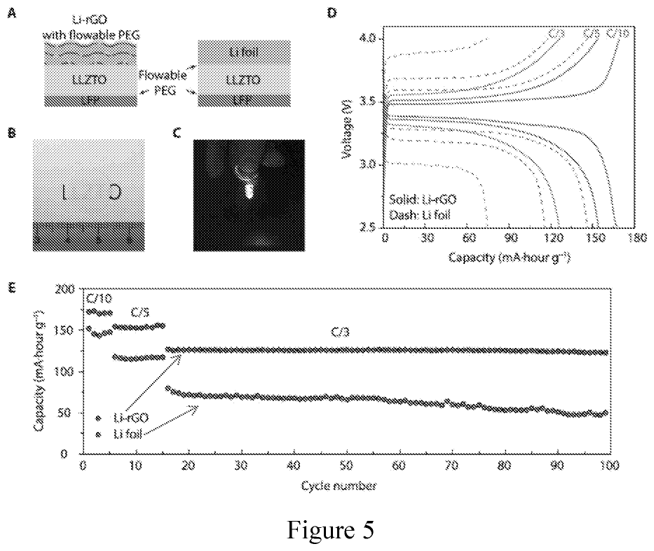

Finally, to demonstrate an effective strategy to solve the interfacial impedance issue in solid Li batteries from an electrode structural design perspective, the general applicability of this 3D Li anode design is demonstrated. Correspondingly, the Li-rGO anode with flowable interphase was also used in Li-LFP cells with a cubic garnet-type LLZTO ceramic electrolyte middle layer (FIG. 25). The Li-LFP coin cells with LLZTO middle layer were constructed following the schematic shown in FIG. 5a (cathode active material has a mass loading of about 1.5 mg cm⁻²). A thin layer (about 10 μL) of flowable PEG was introduced on both Li foil and LFP cathode to reduce the interfacial resistance. FIG. 5b shows a digital photo image of the translucent LLZTO pellet, and the thickness of which was about 400 When operated at room temperature (FIG. 5c), the Li-LFP cells using 3D Li metal anode demonstrated much lower charge/discharge overpotential and improved specific capacity compared to the Li foil reference cells (FIG. 5d). Moreover, significantly improved rate capability and cycling stability can also be observed when replacing the Li foil with the improved 3D Li anode design (FIG. 5e). Therefore, the 3D Li metal anode with flowable interphase is highly promising to be applied generally in conjunction with different solid electrolyte systems in order to address the interfacial impedance challenge in solid-state Li metal batteries.

### Conclusions

To summarize, the large interfacial resistance of solid-state Li metal batteries caused by the poor Li-solid electrolyte adhesion is an outstanding roadblock to their high power and high capacity operations. Although the development of improved solid electrolytes is desired to address this challenge, it can be also important to improve the structural design of solid-state Li metal batteries by leveraging advances in nanomaterial synthesis. In attempt to fill the gap, an improved approach is presented in this example to address the problem of Li-solid electrolyte adhesion: while other designs are based on a planar Li foil, this evaluation adopted a 3D Li anode for the construction of solid Li batteries. The high surface area Li can significantly reduce the effective current density and the degree of volumetric change, giving rise to improved battery kinetics and reduced possibility of electrolyte delamination. The 3D Li anode surface was ionically connected to the bulk solid electrolyte via a flowable polymer electrolyte interphase, which is desired for accommodating the interfacial fluctuation during cycling to maintain an intimate contact. As a consequence, much reduced overpotential and greatly improved cycling stability were realized in both symmetric and full-cell configurations. The adoption of 3D Li anode with flowable interphase proves an improved design principle and can open up possibilities for the next-generation high-energy solid-state Li batteries and their safe operation.

### Materials and Methods

Fabrication of 3D Li-rGO electrode with flowable interphase. The composite Li metal-rGO electrode was fabricated using a procedure set forth in Lin, D. et al., “Layered reduced graphene oxide with nanoscale interlayer gaps as a stable host for lithium metal anodes,” Nat. Nanotech. 11, 626-632 (2016), and punched into about 1 cm² discs (thickness of about 100-150 μm). The flowable interphase layer was obtained subsequently via thermal infiltration of molten SPE into the 3D Li-rGO electrode. Specifically, PEG (Sigma-Aldrich, M_{w} of about 10,000) and LiTFSI (Sigma-Aldrich, 99.95%) were mixed with about 8 to 1 [EO] to [Li] ratio and heated on a hotplate at about 150° C. with gentle stirring to afford a homogenous molten SPE. The Li-rGO electrode was then immersed into the molten SPE and the infiltration process was carried out under vacuum for about 15 min. Finally, the excess SPE on the surface of the Li-rGO electrode was removed using polyester cleanroom swabs.

The whole fabrication process was carried out in an argon-filled glovebox with sub-ppm O₂ and H₂O level (Vigor Tech).

Fabrication of CPE middle layer. To fabricate the CPE middle layer, about 0.6 g PEO (Sigma-Aldrich, M_{w} of about 300,000) was dissolved in about 10 g acetonitrile (Sigma-Aldrich, anhydrous, 99.8%) under vigorous stirring. Then about 0.06 g of fumed silica (Sigma-Aldrich, about 14 nm) was added and the mixture was stirred for at least about two days to afford a homogeneous solution. Subsequently, LiTFSI salt was added in an about 8 to 1 [EO] to [Li] ratio and the solution was stirred until the salt was well dissolved. The CPE solution was then casted into a Teflon evaporating dish (Fisher Scientific, about 63 mm in diameter) and the solvent was evaporated naturally over a period of about one day. The as-obtained CPE was further baked on an about 80° C. hotplate for at least about three days to remove a trace amount of water. The crosslinked PEGDA electrolyte was fabricated by photo-curing an electrolyte precursor composed of about 6:4:8 (weight ratio) PEGDA (M_{w} of about 700, with about 1 wt. % CIBA IRGACURE 819/succinonitrile/LiTFSI under about 360 nm ultraviolet light. This electrolyte precursor can also be infiltrated into the 3D porous Li-rGO electrode followed by photo-curing to construct a relatively rigid interphase. The whole fabrication process was carried out in an argon-filled glovebox with sub-ppm O₂ and H₂O level.

Fabrication of ceramic electrolyte middle layer. The cubic garnet-type LLZTO ceramic electrolyte was synthesized by solid-state reaction of stoichiometric amounts of Li₂CO₃ (Sinopharm Chemical Reagent, 99.99%, with about 20% excess), La₂O₃ (Sinopharm Chemical Reagent, 99.99%, dried at about 900° C. for about 12 hours), ZrO₂ (Aladdin, 99.99%) and Ta₂O₅ (Ourchem, 99.99%). The starting materials were fully grounded with agate mortar and pestle, and then heated at about 900° C. for about 6 hours to decompose the metal salts. The resulting powders were then ball-milled with about 1.2 wt. % of A1₂O₃ for about 12 hours and pressed into a pellet under about 60 MPa cold isostatic pressing for about 120 seconds. The pellet was placed in an alumina crucible, covered with mother powder, and sintered at about 1140° C. for about 16 hours in air atmosphere. To obtain the LLZTO membranes, the sintered LLZTO pellet was sliced using a low-speed diamond saw and the thickness of the LLZTO membranes was about 400 μm. The surface of the LLZTO membranes was polished in an argon-filled glovebox with sub-ppm O₂ and H₂O level using polishing papers with a grit number of 600 before use.

Fabrication of LFP cathode. LFP powders (MTI Inc.) and Ketjenblack (Akzo Nobel, EC 300J) were first dried in vacuum oven at about 60° C. for about 24 hours to remove trapped water. CPE (PEO, LiTFSI, fumed silica, same as described above) dissolved in acetonitrile was used as a binder. To prepare the LFP electrode, LFP, CPE and Ketjenblack in the ratio of about 65:20:15 were dispersed in acetonitrile and homogenized using a planetary centrifugal mixer (THINKY ARE-310). The slurry was then uniformly coated on Al foil via doctor blading. The active material mass loading was controlled to be about 6.0 mg cm⁻². The LFP cathode was dried at about 80° C. for at least about three days inside an argon-filled glovebox with sub-ppm O₂ and H₂O level before use.

Characterizations. The SEM images were taken with a FEI XL30 Sirion scanning electron microscope. The DSC measurement was carried out on a TA Instrument Q2000 differential scanning calorimeter. The samples were sealed in hermetic aluminum pans (Tzero) and first equilibrated at about −80° C. The second heating curves at a ramping rate of about 5° C. min⁻¹ were collected. The rheological properties of the PEG electrolyte were measured using a high-resolution 25 mm parallel-plate rheometer (TA Instrument ARES-G2) with a gap of about 0.5 mm. Oscillation sweep was performed at about 1% strain at various temperatures. X-ray diffraction (XRD) patterns were recorded on a PANalytical X′Pert instrument. For the imaging of the electrode surface after cycling, focused ion beam (FIB) was employed to mill away the polymer electrolyte on the surface, which was carried out using a FEI Strata 235DB dual-beam FIB/SEM with Gallium ion source.

The porosity of the Li-rGO anode was tested via mineral oil absorption. The weight of the Li-rGO electrodes (about 1 cm², about 5 mg) was measured first and then immersed into mineral oil (Light, Fisher Chemical) for about 10 minutes to ensure the substantially complete infiltration of mineral oil into the pores of Li-rGO. Then, the mineral oil infiltrated Li-rGO electrodes were carefully wiped with Kimwipes (Kimtech Science) to substantially completely remove the surface mineral oil residue before weighing. Since the densities of Li (0.534 g cm⁻³) and mineral oil (0.83 g cm⁻³) are given, the volume fraction of mineral oil (occupying the pore space) within the Li-rGO electrodes can be calculated.

Electrochemical testing. For ionic conductivity measurement, symmetric stainless steel/polymer electrolyte/stainless steel cells were assembled and measurements were made every about 10° C. ranging from 0° C. to about 90° C. For electrochemical stability window measurement, Li/polymer electrolyte/stainless steel cells were assembled and the CV was scanned first to negative direction at a scan rate of about 0.1 mV s⁻¹. For the exchange current density measurement, a three-electrode Swagelok cell was used. A half-charged LFP electrode was used as the reference and the working and counter electrodes are both the materials of interest. Linear scan voltammetry was carried out at a scan rate of about 0.1 mV/s. At low current, the Butler-Volmer equation can be approximated to a linear relationship i=i₀(F/RT)η, where η is the overpotential. The exchange current i₀ can be extracted from the slope of the η-i curve. For solid-state symmetric cells, the CPE middle layer was sandwiched between Li metal foils (Alfa Aesar, 0.75 mm, 99.9%) or the 3D Li-rGO electrode with flowable interphase. For solid-state full cells, the CPE middle layer or LLZTO membrane was sandwiched between Li metal foil/3D Li-rGO electrode with flowable interphase, and LFP cathode. Electrochemical impedance measurements were carried out in coin cells on a Biologic VMP3 system. Galvanostatic cycling was conducted on an eight-channel battery tester (Wuhan LAND Electronics Co., Ltd.). The temperature of the cells was controlled by an environmental chamber (BTU-133, ESPEC North America, Inc.) with a precision of ±0.1°C.

As used herein, the singular terms “a,” “an,” and “the” may include plural referents unless the context clearly dictates otherwise. Thus, for example, reference to an object may include multiple objects unless the context clearly dictates otherwise.

As used herein, the terms “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is circular or spherical can refer to a diameter of the object. In the case of an object that is non-circular or non-spherical, a size of the object can refer to a diameter of a corresponding circular or spherical object, where the corresponding circular or spherical object exhibits or has a particular set of derivable or measurable characteristics that are substantially the same as those of the non-circular or non-spherical object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a range of about 1 to about 200 should be understood to include the explicitly recited limits of about 1 and about 200, but also to include individual values such as about 2, about 3, and about 4, and sub-ranges such as about 10 to about 50, about 20 to about 100, and so forth.

While this disclosure has been described with reference to the specific embodiments thereof, it should be understood by those skilled in the art that various changes may be made and equivalents may be substituted without departing from the true spirit and scope of this disclosure as defined by the appended claims. In addition, many modifications may be made to adapt a particular situation, material, composition of matter, method, operation or operations, to the objective, spirit and scope of this disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of this disclosure. Accordingly, unless specifically indicated herein, the order and grouping of the operations are not a limitation of this disclosure.

1. A composite lithium metal anode comprising:
a porous matrix; and
a flowable interphase and lithium metal disposed within the porous matrix.

2. The composite lithium metal anode of claim 1, wherein the porous matrix includes a layered material.

3. The composite lithium metal anode of claim 2, wherein the layered material is reduced graphene oxide.

4. The composite lithium metal anode of claim 1, wherein the flowable interphase includes a polymer and a plasticizer.

5. The composite lithium metal anode of claim 4, wherein the polymer is a polyether.

6. The composite lithium metal anode of claim 5, wherein the plasticizer is a lithium-containing salt.

7. The composite lithium metal anode of claim 1, wherein the flowable interphase is a viscous gel.

8. The composite lithium metal anode of claim 1, wherein the flowable interphase has a complex viscosity, at 10 Hz and 40° C., of 60 Pa·s or less.

9. The composite lithium metal anode of claim 1, wherein the flowable interphase has an ionic conductivity, at 40° C. with respect to Li⁺, of at least 10⁻⁷ S cm⁻¹.

10. The composite lithium metal anode of claim 1, wherein the flowable interphase is amorphous.

11. The composite lithium metal anode of claim 1, wherein the lithium metal includes lithium domains having at least one dimension in a range of 1 nm to 1000 nm.

12. A lithium battery comprising:
a cathode;
the composite lithium metal anode of claim 1; and
an electrolyte disposed between the cathode and the composite lithium metal anode.

13. The lithium battery of claim 12, wherein the electrolyte is a solid electrolyte.

14. A method of manufacturing a composite lithium metal anode, comprising:
providing a porous matrix;
infusing liquefied lithium metal into the porous matrix; and
infusing a composition including a polymer and a plasticizer into the porous matrix.

15. The method of claim 14, wherein the porous matrix includes layered reduced graphene oxide.

16. The method of claim 14, wherein infusing the composition is subsequent to infusing the liquefied lithium metal.

17. The method of claim 14, wherein the composition is a viscous gel.

18. The method of claim 14, wherein the polymer is a polyether, and the plasticizer is a lithium-containing salt.

19. The method of claim 18, wherein a concentration of the lithium-containing salt in the composition is such that an ether oxygen to Li molar ratio is 12:1 or less.
